(19) United States
(12) Patent Application Publication
(10) Pub. No.: US 2005/0162559 A1
(43) Pub. Date: Jul. 28, 2005

(54) Method and apparatus for processing signals

(75) Inventors: Clemens Schopper, Gross-Zimmern (DE); Sven Papke, Heppenheim (DE)

Correspondence Address: Joseph S Tripoli;Thomson Licensing Inc, Patent Operations, Two Independence Way, Princeton, NJ, 08543-5312, US

(73) Assignee: Thomson Licensing S.A., Boulogne-Billancourt (FR)

(21) Appl. No.: 10/509,219

(22) PCT Filed: Mar. 18, 2003
(86) PCT No.: PCT/EP03/02786

(30) Foreign Application Priority Data
Mar. 30, 2002 (DE) 102 14 397.8

(51) Int. Cl. H04N 9/74

(52) U.S. Cl. 348/595

(57) ABSTRACT

In a method and an apparatus for cross-fading video signals, each avideo signal to be cross-faded is assigned a specific cross-fading function. A graphical user interface is provided for inputting the cross-fading functions. The graphical user interface has different fields for inputting parameters of the corss-fading functions which are written to a store. For the control of the cross-fading operation by a control computer, the cross-fading functions are read from the store.

The invention relates to a method and an apparatus for processing signals. A signal processing apparatus has, for cross-fading signals, at least one cross-fading device, in which a plurality of inputs for receiving input signals are provided and in which an output signal can be tapped off at an output. Furthermore, the apparatus has a control apparatus for controlling the cross-fading device.

Video contributions are produced using video mixers whose video inputs are connected to outputs of different video signal sources. By means of a crossbar, specific video signals can be selected and mixed in assigned M/E units (mix effect units) and/or cross-faded. Video mixers may furthermore contain units which can be used to carry out, in addition to mixing and cross-fading functions, special trick functions as well, for example trick functions according to an inlay, chroma-key or electronic mask method. The selection of the input signals for the different signal processing units and the setting for the progression of specific trick functions are effected via an operating console provided with a multiplicity of pushbuttons, levers and rotary knobs.

Various types of picture cross-fading are known. In the case of a so-called X cross-fading, the picture component of a first video signal is reduced from a maximum value down to zero, while the picture component of a second video signal is at the same time raised from zero to its maximum value. In the case of V cross-fading, by contrast, the picture component of the first video signal is firstly reduced completely to zero before the picture component of the second video signal is increased.

Although present-day professional video mixers already have a multiplicity of cross-fading variants for image processing, there is a desire from artistic standpoints to use further picture configuring variants for television production. At the same time, there is a requirement to simplify the operation of a professional video mixer, whose complexity is continuously increasing in any case.

In the apparatus according to the invention, a control apparatus for controlling the cross-fading device has an input means for inputting a specific cross-fading function for each input signal to be cross-faded.

The invention has the advantage that the input signals can be assigned different cross-fading functions. It is thus possible to cross-fade video signals with an offset, i.e. to configure differently the temporal sequence with which the video signals to be cross-faded are faded in and out. Furthermore, it is advantageous that the apparatus according to the invention is suitable not only for cross-fading video signals, but also for cross-fading key and audio signals.

In one development of the invention, it is provided that the cross-fading functions assigned to the individual input signals can be written to a store and can be read from the store for a cross-fading operation. Through the retrieval of stored cross-fading functions, cross-fading variants that have been input can be repeated as often as desired. The sequence of a stored cross-fading variant can be carried out both manually and automatically.

In another development of the invention, it is provided that the start time and the end time of the cross-fading function assigned to an input signal can be defined within a cross-fading interval. The direction of the fading profile within the cross-fading interval can be chosen. Moreover, it is possible to stipulate whether the cross-fading functions assigned to the individual input signals are intended to proceed linearly or nonlinearly. Furthermore, an operator can decide through inputting whether he would like to additively cross-fade the input signals to be cross-faded.

In accordance with one refinement of the invention, the input means for inputting the specific cross-fading functions has a graphical user interface. The graphical user interface for a video mixer is advantageously configured such that it is possible to select riot only the video signals present at the inputs of the video mixer bug also key, matte and graphic character signals generated in the video mixer, and audio signals transmitted in parallel with the video signals. The individual parameters of the cross-fading function of a selected signal can advantageously likewise be set with the aid of the graphical user interface.

According to one advantageous development of the invention, the graphical user interface has a field which reproduces the time base of the input signals to be cross-faded within the cross-fading interval. This type of representation allows the cross-fading function of the selected input signals to be represented as bars and said bars to be displaced both in terms of length and spatially Within the cross-fading interval.

In another advantageous development of the invention, the graphical user interface has a field which displays the path of the cross-fading as a function of time in the cross-fading interval. The profile of the cross-fading functions can be altered with this type of representation.

Furthermore, the graphical user interface may also contain a field which reproduces the functional profile of an additive cross-fading of the input signals to be cross-faded.

The invention will now be described and explained in more detail using an exemplary embodiment illustrated in the drawing, in which:

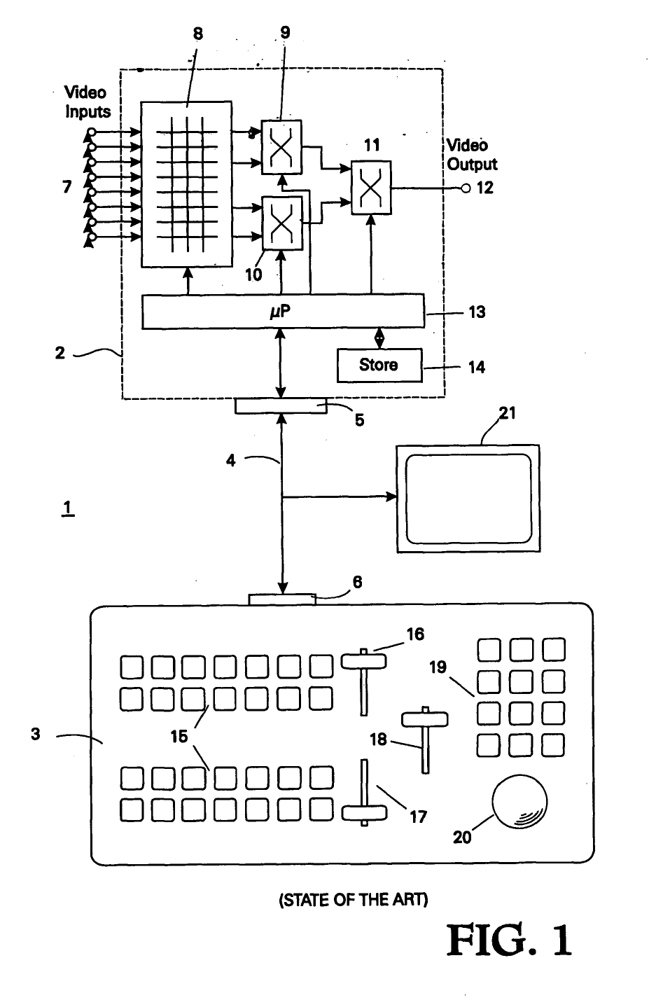

FIG. 1 shows the block diagram of a video mixer according to the prior art, and

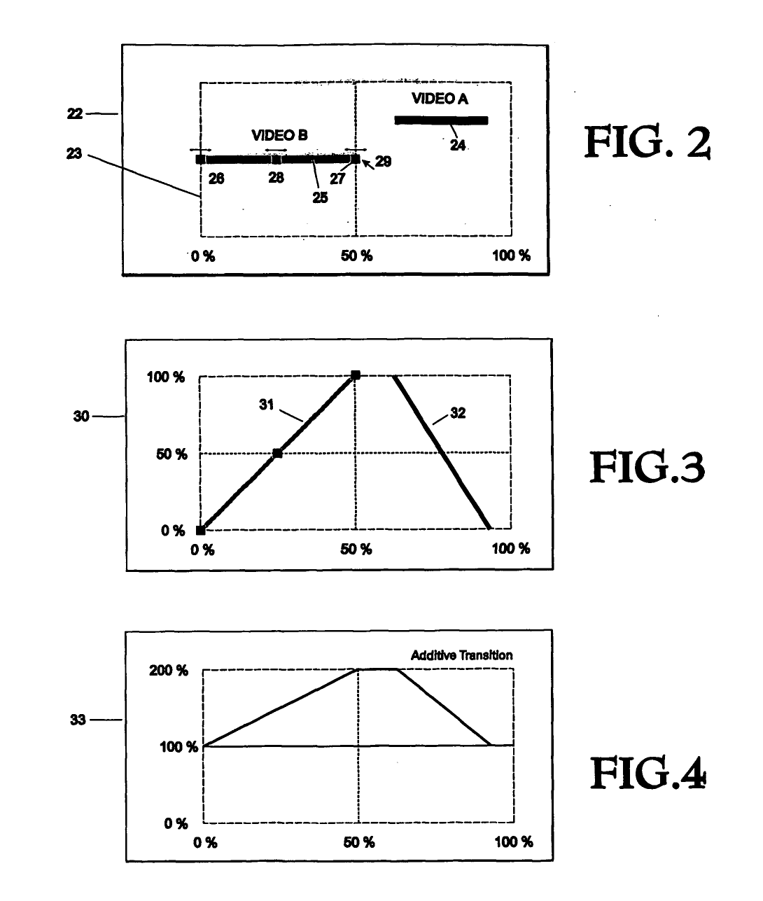

FIG. 2 to 4 show different representations for the display and inputting of cross-fading functions according to the invention.

In FIG. 1, 1 designates a video mixer known per se, which essentially comprises two equipment components: a signal processing device 2 and an operating console 3. The signal processing device 2 and the operating console 3 are connected via a local area network 4, preferably a Cheapernet. For data communication via the local area network 4, the signal processing device 2 contains an interface 5 and the operating console 3 contains an interface 6.

The signal processing device 2 of a video mixer 1 is known per se. By way of example, inputs 7 for video signals, a crossbar 8 and cross-fading devices 9, 10 and 11 and also an output 12 for outputting a video signal are represented for illustration purposes. The crossbar 8 and the cross-fading devices 9 to 11 are controlled by a control computer 13, which converts commands arriving via the local are a network 4 into actuating signals for the crossbar 8 and the cross-fading devices 9 to 11. A store 14 that can be accessed in random fashion is connected bidirectionally to the control computer 13. The store 14 contains a control program and control data.

The operating console 3 contains keys 15 for selecting the video signals to be mixed, cross-fading levers 16, 17 and 18 and also a series of other operating elements which are not illustrated in FIG. 1. Such operating elements serve, for example, for selecting trick figures (key pattern, templates) or for setting color signal values for chroma-key purposes or for color area generator signals (matte signals). The latter are signals which can represent an essentially one- or two-colored area with continuous or trick-pattern-controlled color transitions and be used as required as a background signal or for filling other areas in the picture. From the operating console 3, it is also possible to operate video recorders, laser disks, disk recorders or external video effects devices, for example to switch them into the reproduction or recording mode.

For inputting data, a key block 19 is provided on the operating console 3. The operating console 3 additionally contains a tracking ball 20 which controls the movement of a mouse pointer on the display screen of a monitor 21. The input of the monitor 21 is connected to the local area network 4. In order that the data transmitted by the local area network 4 can be represented on the display screen of the monitor 21, a graphics card (not illustrated) is provided which converts the transmitted data into a VGA signal.

A program—stored in the store 14—for controlling the control computer 13 is embodied such that a graphical user interface is represented on the display screen of the monitor 21. For the assignment of specific transfer functions of the video signals to be cross-faded, the graphical user interface has inter alia three-fields, which are explained in more detail in connection with FIGS. 2, 3 and 4.

The field 22 represented in FIG. 2 contains a frame 23 depicted by dashes. The frame 23 depicted by dashes bounds a cross-fading interval in the horizontal direction. The cross-fading interval begins at 0% and ends at 100%. Within the cross-fading interval, the picture component of a video signal A is cross-faded to the picture component of a video signal B. Situated in the frame 23 depicted by dashes there is a bar 24 which may be assigned to the video signal A. The video signal B shall be represented by a bar 25. The length and position of the bars 24 and 25 can be altered. For this purpose, by way of example, the bar 25 is provided with holding points 26 and 27 at its end and with a holding point 28 at its center. The length of the bar 25 can be changed by clicking on a holding point 26 or 27, respectively, using a mouse pointer 29. The entire bar 25 can be displaced in the horizontal direction by clicking on and dragging the holding point 28.

For reasons of clarity, only two bars representing video signals have been depicted in the frame 23 depicted by dashes. It goes without saying that other signals, such as key or audio signals, may also be included in the frame 23 in order that the type of cross-fading of these signals is also defined therefor. With application of the invention, audio signals transmitted in parallel with the video signals can be cross-faded in a different way than the video signals. Through corresponding setting of the cross-fading functions, it is possible, for example, for an audio signal to be faded out or in temporally prior to the associated video signal. The time at which a signal is faded in and out can be defined individually. The previously customary rigid coupling of the signals to be cross-faded is broken down in the case of the subject matter of the present invention. Merely moving a cross-fading lever 16 to 19 no longer has the effect that all the signals incorporated into a cross-fading operation are cross-faded in the same way.

The invention also allows the definition of different types of cross-fading in a direction-dependent manner. In the case of a normal cross-fading, the signals preset in the type of cross-fading are cross-faded from 0% in the direction of 100% of the cross-fading interval. In the case of a reverse cross-fading, the cross-fading of the signals takes place from 100% in the direction of 0% of the cross-fading interval when a cross-fading lever is moved. In the casde of a so-called normal/reverse cross-fading, by way of example, cross-fading is effected from 0% in the direction of 100% when the cross-fading lever is moved in a first direction, and from 100% in the direction of 0% when the cross-fading lever is moved in a second direction.

A field 30 shown in FIG. 3 likewise contains a frame depicted by dashes. The travel of a cross-fading lever in percent is plotted on the ordinate of said frame; the abscissa shows the cross-fading interval in percent. The straight line 31 describes the cross-fading function of the video signal B in the cross-fading interval, i.e. the path of the cross-fading as a function of time. The straight line 31 also has holding points. The holding points correspond to the holding points 26 to 27 of the bar 25. Changing a holding point in FIG. 2 also leads, in parallel, to a spatial change in the corresponding holding point in FIG. 3, and vice versa. Increasing or decreasing the size of the bar 25 changes the gradient of the straight line 31 and, linked with this, changes the cross-fading function of the assigned video signal B.

The cross-fading function of the video signal A can also be changed in a corresponding manner. In FIG. 3, the straight line 32 represents the cross-fading function of the video signal A. In the present exemplary embodiment, firstly the video signal B is completely faded in in the first half of the cross-fading interval (0% to 50%) before the video signal A is faded out within the range from 60% to 90% of the cross-fading interval.

FIG. 4 shows a field 33 in which, coupled with the cross-fading values input in the fields 22 and 30, an additive cross-fading function is represented. A value range of 200% is plotted on the ordinate of this representation. The cross-fading interval is plotted on the scale of the fields 22 and 30 on the abscissa. The cross-fading function of a program video signal and of a preview video signal is usually represented in the field 33.

1. A signal processing apparatus having at least one cross-fading device for cross-fading signals, in which a plurality of inputs for receiving input signals are provided and in which an output signal can be tapped off at an output, and having a control apparatus for controlling the cross-fading device, wherein the control apparatus has an input means for inputting a specific cross-fading function for each input signal to be cross-faded.

2. The signal processing apparatus as claimed in claim 1, wherein the cross-fading function assigned by inputting to each input signal to be cross-faded can be written to a store and can be read from the store for a cross-fading operation.

3. The signal processing apparatus as claimed in claim 1, wherein the start time and the end time of the cross-fading function assigned to an input signal can be defined within a cross-fading interval.

4. The signal processing apparatus as claimed in claim 1, wherein the direction of the fading profile can be chosen within the cross-fading interval.

5. The signal processing apparatus as claimed in claim 1, wherein a means for inputting a linear and/or nonlinear profile of the cross-fading function for each input signal is provided.

6. The signal processing apparatus as claimed in claim 5, wherein the input signals can be additively cross-faded in a manner dependent on defined assigned cross-fading functions.

7. The signal processing apparatus as claims in claim 1, wherein the input means for inputting specific cross-fading functions has a graphical user interface.

8. The signal processing apparatus as claimed in claim 6, comprising a graphical user interface having
a representation of the time base of the input signals to be cross-faded within the cross-fading interval and/or
a representation of the profiles of the cross-fading functions of the input signals to be cross-faded within the cross-fading of the input signals to be cross-faded within the cross-fading interval.

9. A method for processing signals, in which a plurality of input signals are cross-faded in a control-dependent manner in order to generate an output signal, wherein each input signal to be cross-faded is assigned a specific cross-fading function.
